(19) United States
(12) Patent Application Publication
(10) Pub. No.: US 2015/0072256 A1
(43) Pub. Date: Mar. 12, 2015

(54) REFILLABEL HYDROGEN GENERATOR

(71) Applicant: Intelligent Energy Inc., San Jose, CA (US)

(72) Inventors: Jean-Francois Audebert, Westlake, OH (US); Olen R. Vanderleden, Port Moody (CA); Richard A. Langan, Parma, OH (US); Chad E. Law, Milan, OH (US); Thomas J. Kmetich, Willoughby Hills, OH (US); Craig R. Huddleston, Lakewood, OH (US); Jason L. Stimits, Avon, OH (US); Gerald Zsigo, North Ridgeville, OH (US); Kevin P. Murray, Schaumburg, IL (US)

(73) Assignee: INTELLIGENT ENERGY INC.

(21) Appl. No.: 14/541,047

(22) Filed: Nov. 13, 2014

Related U.S. Application Data
(63) Continuation of application No. PCT/US2013/040905, filed on May 14, 2013.
(60) Provisional application No. 61/647,535, filed on May 16, 2012.

(51) Int. Cl. B01J 19/12; C01B 3/04; H01M 8/06

(52) U.S. Cl. CPC B01J 19/121; H01M 8/0606; C01B 3/04
USPC 429/423; 422/164

(57) ABSTRACT

A hydrogen generator and a fuel cell system including the hydrogen generator are disclosed. The hydrogen generator includes a reactant that undergoes a thermal decomposition reaction to produce hydrogen when heated. A laser is used to initiate the reaction. The reactant is contained in a reactant composition in a user-replaceable disc-shaped fuel unit. The reactant composition can be segregated into individual quantities. The fuel unit and the laser beam are periodically realigned by incrementally rotating the fuel unit and/or incrementally redirect the laser beam.

### CROSS-REFERENCE TO RELATED APPLICATION

This application is a Continuation of International Patent Application PCT/US2013/040905 filed May 14, 2013, which claims priority to, and benefit of, U.S. Provisional Patent Application No. 61/647,535, filed on May 16, 2012, the contents of which are incorporated by this reference as if fully set forth herein, in their entirety.

### TECHNICAL FIELD

This invention relates to a hydrogen generator for providing hydrogen gas, particularly a hydrogen generator that can be refilled with a hydrogen-containing reactant. The invention also relates to a fuel cell system including the hydrogen generator and a hydrogen fuel cell that can be provided with hydrogen gas by the hydrogen generator.

### BACKGROUND

Interest in fuel cell batteries as power sources for portable electronic devices has grown. A fuel cell is an electrochemical cell that uses materials from outside the cell as the active materials for the positive and negative electrode. Because a fuel cell does not have to contain all of the active materials used to generate electricity, the fuel cell can be made with a small volume relative to the amount of electrical energy produced compared to other types of batteries.

Fuel cells can be categorized according to the type of electrolyte used, typically one of five types: proton exchange membrane fuel cell (PEMFC), alkaline fuel cell (AFC), phosphoric-acid fuel cell (PAFC), solid oxide fuel cell (SOFC) and molten carbonate fuel cell (MCFC). Each of these types of fuel cell can use hydrogen and oxygen as the active materials of the fuel cell negative electrode (anode) and positive electrode (cathode), respectively. Hydrogen is oxidized at the negative electrode, and oxygen is reduced at the positive electrode. Ions pass through an electrically nonconductive, ion permeable separator and electrons pass through an external circuit to provide an electric current.

In some types of hydrogen fuel cells, hydrogen is formed from a hydrogen containing fuel supplied to the negative electrode side of the fuel cell. In other types of hydrogen fuel cells, hydrogen gas is supplied to the fuel cell from a source outside the fuel cell.

A fuel cell system can include a fuel cell battery, including one or more fuel cells (e.g., a fuel cell stack), and a fuel source, such as a fuel tank or a hydrogen generator. Hydrogen generators that supply hydrogen gas to a fuel cell can be an integral part of a fuel cell system, or they can be removably coupled to the fuel cell system. A removable hydrogen generator can be replaced with another one when the hydrogen producing reactants have been consumed. Removable hydrogen generators can be disposable (intended for only a one-time use). Both removable and permanently installed hydrogen generators can be refillable (intended for use multiple times) to replace consumed reactant materials.

Hydrogen generators can produce hydrogen using a variety of reactants and a variety of methods for initiating the hydrogen generating reactants. Hydrogen gas can be evolved when a hydrogen containing material reacts. Examples of hydrogen containing materials include liquid or gaseous hydrocarbons (such as methanol), hydrides (such as metal hydrides and chemical hydrides), alkali metal silicides, metal/silica gels, water, alcohols, dilute acids and organic fuels (such as N-ethylcarbazone and perhydrofluorene). A hydrogen containing compound can react with another reactant to produce hydrogen gas, when the reactants are mixed together, in the presence of a catalyst, heat or an acid, or a combination thereof. A hydrogen containing compound can be heated to evolve hydrogen in a thermochemical decomposition reaction.

In selecting reactants for use in a hydrogen generator, consideration may be given to the following: (a) stability during long periods of time when the hydrogen generator is not in use, (b) ease of initiation of a hydrogen generating reaction, (c) the amount of energy that must be provided to sustain the hydrogen generating reaction, (d) the maximum operating temperature of the hydrogen generating reaction, and (e) the total volume of hydrogen that can be produced per unit of volume and per unit of mass of the reactant(s).

In order to provide hydrogen over a long period of time without developing a very high pressure within the hydrogen generator, it is desirable to generate the hydrogen on an as-needed basis. This requires controlling the reaction of the reactant(s), such as by reacting only a limited quantity at a time.

An object of the present invention is to provide a hydrogen generator with one or more of the following features: capable of producing a large total volume of hydrogen gas per unit of mass and per unit of volume of the hydrogen generator, capable of controlling the reaction of the reactant(s) to provide hydrogen on an as needed basis without producing an excessive internal pressure within the hydrogen generator, capable of operating at or below a desired maximum temperature, capable of being refilled with reactants, long term durability and reliability, and having a user replaceable fuel unit that can be made easily and inexpensively.

### SUMMARY

In one aspect of the invention, there is provided a hydrogen generator that includes a holder and a fuel unit. The fuel unit includes a disc shaped substrate having two opposite planar surfaces, at least one of the surfaces having thereon a reactant composition that is a solid hydrogen containing a reactant capable of releasing hydrogen gas by a thermal decomposition reaction when heated to at least a minimum temperature. The holder includes a cavity in which the fuel unit can be removably contained, a laser for projecting a beam of electromagnetic radiation onto a portion of the reactant composition to heat the reactant to at least the minimum temperature. The holder further includes an indexing mechanism for aligning the laser beam and an unreacted portion of the reactant composition, the indexing mechanism including one or both of a disc rotating device for rotationally indexing the disc from a first disc position to a second disc position, and a laser positioning device for indexing the laser beam from a first laser position to a second laser position. Embodiments can include one or more of the following features:
the reactant includes aluminum hydride or an aluminum hydride compound;
the reactant composition contains one or more additives, admixed with, adjacent to, underlying or covering a portion of the reactant composition; the additives can include one or a combination of an electromagnetic energy absorbing medium, a binder, a stabilizing compound, a thermally conductive material and an ignition material;
the reactant composition is free of catalysts;
the fuel unit substrate has an outside diameter from 50 to 150 mm, preferably from 95 to 125 mm; the fuel unit substrate can have a central hole between its surfaces with an inside diameter from 5 to 20 mm, preferably 12 to 18 mm;
the fuel unit substrate includes a polycarbonate material;
the fuel unit contains 15 to 25 grams of reactant;
the reactant composition is segregated into individual portions; the individual portions can be segregated from each other by one or a combination of gaps, ridges of substrate material projecting from a substrate surface, and thermally insulating material on a substrate surface; the individual portions can be part of a honeycomb array, an array of wedges extending radially from a central area of the fuel unit, or an array of concentric bands;
the reactant composition is applied to the substrate surface by printing, extruding, roll coating, or pressure laminating;
the laser can be turned on and off to provide hydrogen gas as needed;
the laser is a laser diode; the laser diode can be a semiconductor laser diode;
the laser uses continuous wave or pulsed power, preferably pulsed power;
the hydrogen generator includes more than one laser;
the disc rotating device includes one or more of a stepper motor, a ratchet mechanism, a chain drive, a belt drive and a worm drive for indexing the disc from a first disc position to a second disc position;
the laser positioning device includes a stepper motor, a ratchet mechanism, a chain drive, a belt drive, a worm drive and one or more minors for indexing the laser beam from a first laser position to a second laser position; the mirror(s) can project the laser beam onto a surface of the fuel unit that does not face the laser;
the holder can contain a plurality of fuel units;
the holder includes a housing; the housing can include portions of a fuel cell system and/or a device with which the fuel cell system and/or the hydrogen generator is used;
the holder is closable to retain the fuel unit; the holder can be sealable to contain pressurized hydrogen gas; the holder can include a pressure relief vent;
the hydrogen generator includes a hydrogen gas outlet that interfaces with a fuel cell system; the outlet can include a valve for controlling release of hydrogen gas; the hydrogen generator can include a filter for removing particulate material from the hydrogen gas;
the hydrogen generator includes an energy source for providing energy to the laser and the indexing mechanism; the energy source can be disposed within the holder or outside the holder; the energy source can include one or more of a primary battery, a secondary battery, a fuel cell, a capacitor, an inverter, and an alternating current utility;
the hydrogen generator includes a control system; a portion of the control system can be disposed within the holder; a portion of the control system can be disposed outside the holder; the control system can control energy for operating the laser; the control system can control operation of the indexing mechanism; the control unit can monitor one or more parameters indicative of the need for hydrogen; the parameter can be temperature, pressure, an electrical characteristic of a fuel cell system, an electrical characteristic of a device being provided with power by the fuel cell system; the control system can include one or a combination of a microprocessor; a microcontroller; digital, analog and hybrid circuitry; solid state and electromechanical switching devices; capacitors; and sensing instrumentation;
the fuel unit is portable; and
the hydrogen generator is portable.

In another aspect of the invention, there is provided a fuel cell system including a fuel cell battery and a hydrogen generator as described above. In an embodiment the fuel cell system is portable.

### BRIEF DESCRIPTION OF THE DRAWINGS

In the drawings:

FIG. 1 is a cross-sectional schematic view of an embodiment of a hydrogen generator;

FIG. 2 is a cross-sectional schematic view of a second embodiment of a hydrogen generator;

FIG. 3 is a perspective view of a fuel unit with a continuous layer of a reactant composition;

FIG. 4 is a top view of the fuel unit with segregated quantities of reactant composition according to a first embodiment;

FIG. 5 is a top view of the fuel unit with segregated quantities of reactant composition according to a second embodiment; and

FIG. 6 is an exploded perspective view of an embodiment of a fuel unit.

### DETAILED DESCRIPTION

The above objects are accomplished by the present invention, which is directed to a hydrogen generator. The present invention is further directed to a fuel cell system including the hydrogen generator and a fuel cell battery (which may be referred to below as a fuel cell or fuel cell stack, whether it contains one or a plurality of fuel cells or fuel cell batteries). The hydrogen generator is a hydrogen gas generating apparatus that produces hydrogen gas that is consumed by a hydrogen consuming apparatus such as a fuel cell battery. The fuel cell battery can provide electricity to an electronic device. Preferably the hydrogen generator is portable, either alone or as part of the fuel cell system or the device. As used herein, portable means readily moved by an individual person, without requiring the use of lifting or transporting equipment (e.g., a hoist, dolly, lift truck or the like).

The hydrogen generator includes one or more reactants that can react to produce hydrogen gas. In order to economically produce a large volume of hydrogen gas per unit relative to its volume and weight, it is advantageous to use a reactant that can undergo a thermal decomposition reaction that produces hydrogen gas when heated. Such thermal decomposition reactions can often produce a larger volume of gas of reactant than, for example, the same amount (per mole, per unit of weight or per unit of volume) of reactants that undergo a hydrolysis reaction. Preferred reactants do not require costly catalysts to undergo the desired hydrogen-generating reactions.

In order to provide an economical hydrogen generator and fuel cell system, it is desirable to be able to replace depleted reactants with fresh reactants, without replacing the entire hydrogen generator. This allows durable components of the hydrogen generator to be used many times and minimizes the cost of the replaceable unit containing reactants. To maximize this effect, it is desirable to incorporate as many reusable components as practical into the reusable portion of the hydrogen generator (referred to below as the holder), the rest of the fuel cell system and/or the device associated with the fuel cell system, and to limit the number of components in the replaceable portion of the hydrogen generator (referred to below as the fuel unit) to the greatest extent practical. This is particularly true for such items that occupy a relatively large volume or are relatively expensive. Ideally, fuel units would contain only the hydrogen generating reactants and minimal packaging. However, for practical reasons it may also be desirable to include other ingredients and components in the fuel units.

The hydrogen generator includes a holder that is configured to receive one or more fuel units and contains at least some of the other components of the hydrogen generator. In some circumstances, it may be desirable to locate at least some portions of those other components outside the holder (e.g., elsewhere in a fuel cell system and/or in the device being supplied with electricity by the fuel cell system). The fuel unit includes a substrate disc with a solid reactant on a surface thereof The fuel unit is loaded into a cavity in the holder, and the holder is closed. An initiation system including a laser projects a laser beam onto an area of the reactant composition, producing sufficient heat to cause the reactant to undergo a thermal decomposition reaction that produces hydrogen gas. The hydrogen gas exits the hydrogen generator and can be provided to a hydrogen consuming apparatus such as a hydrogen fuel cell. Spent fuel units are removed from the holder and replaced with fresh fuel units. During operation of the hydrogen generator, unreacted reactant can be positioned in the laser beam by realigning the laser beam and the fuel unit with an indexing mechanism. A control system can be used to monitor one or more parameters that are indicative of the need for hydrogen, control power to the initiator to provide hydrogen on an as-needed basis, and/or control the operation of the indexing mechanism to selectively initiate the hydrogen-generating reaction in different portions of the fuel unit.

The holder can include a housing of its own, particularly if the holder is intended to be removed from or used while outside the rest of the fuel cell system or device. A separate holder housing may not be desired if the hydrogen generator is contained within the fuel cell system or device. For example, a portion of the fuel cell system or device can serve as all or part of a holder housing. The holder housing has sufficient mechanical strength and resistance to the conditions to which the hydrogen generator is expected to be exposed, particularly to high temperatures and the reactants and byproducts associated with the hydrogen generating reactions. Suitable materials for the housing can include metals such as aluminum, steel and stainless steel; ceramics; high temperature resistant polymers such as polyphenylene sulfide, acrylonitrile butadiene styrene, polyetheretherketone, polyetherimide, polyoxybenzylmethylenglycol anhydride (Bakelite®); epoxies; phenolics; diallyl phthalate; melamine; fiberglass filled composites; and alloys, mixtures and composites (e.g., laminates) thereof In some embodiments the holder may be made from a material that is a poor thermal conductor (e.g., less than 10 watts/meter·Kelvin and preferably less than 1 watt/meter·Kelvin) to protect the rest of the fuel cell system, the device and/or the user from heat produced within the hydrogen generator. If desired, thermal insulation can be added to the hydrogen generator, within the housing, around the housing or elsewhere in the fuel cell system or the device. A vacuum, such as in a hollow space in a wall(s) of the holder, can provide thermal insulation, and materials such as aerogels, fiberglass, rock wool, vermiculite and foam plastics can be used to provide thermal insulation.

The holder includes one or more cavities into which fuel units can be removably inserted. The cavity can include features for aligning the packaged fuel unit in a particular orientation and/or providing a hydrogen gas flow path between the holder and the fuel unit. The holder can be closable to retain the fuel unit within the cavity, and it may be sealable to exclude gases from the outside environment and to contain pressurized hydrogen gas. The housing can include an access lid, door, panel or the like (referred to as a lid below) that can be opened or removed to allow insertion and replacement of fuel units. Opening of the lid can be controlled, such as to prevent removal of hot fuel units.

A sealable housing can contain a limited quantity of hydrogen gas under pressure. To avoid special requirements for a high pressure container, it is desirable to design the hydrogen generator to limit the amount of hydrogen gas that must be contained, such as to a maximum of about 1.36 atmospheres (20 pounds/in²). If internal pressure can build up during operation of the hydrogen generator, it may be desirable to include a pressure relief vent in the housing to release gas before the pressure gets too high (i.e., to prevent an uncontrolled opening or rupture of the housing).

Hydrogen gas produced in the fuel unit flows through a hydrogen flow path to an outlet that interfaces with the rest of the fuel cell system. The hydrogen generator can also include various fittings, valves and electrical connections for providing hydrogen to and interfacing with the fuel cell stack and/or an electrical appliance being provided with power by the fuel cell system. It may be desirable to provide one or more filters or purification units (referred to as filters below) in the hydrogen flow path to remove solid or fluid byproducts (such as fuel cell poisons) and/or unreacted reactant from the hydrogen. Filters can be located within the fuel units, within the holder and/or at the interface between the hydrogen generator and the rest of the fuel cell system. Filters within the fuel units are replaced when the fuel units are replaced. It may be desirable to provide access for periodically replacing filters located outside the fuel units. Examples of materials that may be suitable for filters include silica, silicon dioxide, silicon nitrides, silicon carbide, silica aerogel, alumina, aluminum oxide, glass, glass wool, mineral wool, cellular glass, perlite and polymers such as polyimides and epoxy-amine composites, as well as suitable gas purification units (such as ion exchange resins). It may be possible to position filters so they also provide thermal insulation.

The hydrogen generator includes an initiation system for converting electric energy to thermal energy that can provide heat for a hydrogen-generating thermal decomposition reaction in the fuel unit. The initiation system is located outside the fuel unit and includes an electromagnetic generator capable of producing electromagnetic radiation that will provide heat to initiate the desired reaction. The initiation system is powered by one or more energy sources. Examples of suitable energy sources include a primary battery, a secondary battery, a fuel cell battery, a capacitor and a public utility. An inverter can be used with a direct current power source to provide alternating current if needed. The energy source is preferably outside the fuel unit, such as in the holder, elsewhere in the fuel cell system, in the device, or external to the device. Circuitry in the holder can carry the electric energy to the initiator. After the hydrogen generator is started, a fuel cell battery in the fuel cell system can be used to provide energy to the initiation system if desired.

The initiation system includes one or more electromagnetic initiators (e.g., lasers) that can generate electromagnetic radiation to produce heat. The electromagnetic radiation can have a frequency in the range of visible light (e.g., with a laser), microwaves (e.g., with a microwave laser) or radio waves (e.g., with a radio laser) for example. Any suitable type of laser can be used (e.g., gas, chemical, excimer, solid state, photonic crystal, semiconductor or free electron lasers). The laser wavelength can be selected based in part on the color of the reactant or any additives in the reactant composition to maximize heating efficiency. A laser diode (a laser whose active medium is a semiconductor similar to that found in a light-emitting diode) is a preferred type of lasers. The initiator can be used in a continuous wave or pulsed operation, depending on the laser used and the heating requirements. Pulsed operation can be used to minimize the energy required to operate the laser and to prevent overheating of the laser. The initiator can be turned on and off as needed to provide hydrogen gas on an as-needed basis. One or more lenses can be used in combination with a laser to narrow or broaden the area the laser beam will cover.

One or more fuel units can be inserted into a corresponding cavity or cavities in the holder. Each fuel unit has a composition containing a reactant on a substrate. The substrate is in the shape of a disc that can be rotated in the holder. The radiation heats the reactant composition, causing it to react. The reactant composition includes one or more reactants that are capable of releasing hydrogen gas when heated to or above a critical temperature, at which the desired thermal decomposition of the reactant begins.

The fuel unit substrate is preferably a rigid material that is stable at the expected reaction temperatures. It should not deform (e.g., by melting, shrinking or warping) to the extent that operation of the hydrogen generator or removal of the fuel unit from the holder is adversely affected, and it should not deteriorate when in contact with the reaction composition or when heated to produce reaction products that can damage the hydrogen consuming apparatus. If the reactant composition is irradiated through the substrate, the substrate must be made of a material that will allow the electromagnetic radiation to pass through with minimal energy loss (e.g., a clear substrate material can be used with a laser emitting radiation in the frequency range of visible light). Thermoplastics such as polycarbonates, polyetheretherketone, polyimides, polyamideimides, polyetherimide, polysulphones, polyether sulphone, polyphenylene sulphide, liquid crystal polymers and composites (e.g., glass or carbon filled, laminated with another thermoplastic, or a metal such as a steel or aluminum) thereof are examples of materials that may be suitable, depending on the maximum operating temperature. If the substrate includes a polymer, the glass transition temperature is preferably less than the maximum operating temperature.

The reaction composition can be present as a continuous or a discontinuous layer. For example, quantities of reactant composition can be segregated from one another in various ways such as by containment in individual compartments and/or being spaced apart by gaps, coatings, thermal insulation and the like. The reactant composition can be disposed on one or both sides of the substrate. If reactant composition is disposed on both sides of the substrate, a separate initiator may be needed for each side. Alternatively, one or more mirrors can be used to split a laser beam and/or redirect a laser beam so a single laser can be used to irradiate reactant composition on both sides of the disc.

The reaction composition contains at least one hydrogen containing reactant. More than one reactant can be included. Examples of reactants that can evolve hydrogen gas upon thermal decomposition are: lithium imide (Li2NH), lithium amide (LiNH2), an ammonium halide (e.g., NH₄F, NH₄Cl or N₂H₆Cl₂) plus a chemical hydride (e.g., LiH, LiBH₄, NaBH₄, LiAlH₄ or NaAlH₄), magnesium hydride (M_{g}H₂) or magnesium hydride compounds (e.g., Mg₂NiHₓ, La₂Mg₁₇Hₓ or Mg₂CuHₓ), alane (AlH₃), ammonia borane (NH₃BH₃), ammonia borane plus a chemical hydride (e.g., alane or a boron hydrazine complex such as hydrazine bisborane (N₂H₄(BH₃)₂)), ammonium nitrate (NH₄NO₃) plus diammonium decaborane (B₁₀H₁₀(NH₄)₂), and other materials, such as graphene and carbon nanotubes with hydrogen inserted therein. Choices of reactants may be limited by other factors such as physical and chemical properties of the reactant, the type of initiation system being used, the temperature range for the desired thermal decomposition reaction, whether the hydrogen-generating reaction is exothermic or endothermic, the composition, form and properties of reaction byproducts, and so on.

The reactant composition can also contain one or more additives. Examples of additives include electromagnetic energy absorbing media as described below, binders (e.g., acrylates, styrene block copolymers, polypropylene and polytetrafluoroethylene), stabilizing materials (e.g., air and/or water impermeable materials such as polypropylene, polyethylene, polyetheretherketone and nonporous ceramics), thermally conductive materials (e.g., metals, graphites and combinations and composites thereof), and ignition materials as described below. Additional layers can be used in combination with a layer of reactant composition, such as layers of electromagnetic energy absorbing, stabilizing, thermally conductive, thermally insulating materials. When a coating layer is applied over the layer of reactant composition, provision must be made for the release of hydrogen gas as it is being produced. This can be through the coating layer, around exposed edges of the reactant composition, through the substrate or any combination thereof Preferably catalysts are not included in the reactant composition.

If the reactant composition would otherwise absorb insufficient energy from the electromagnetic radiation to achieve the desired heating effects, an electromagnetic energy absorbing medium can be added. The material can be selected based on the frequency of the electromagnetic radiation. Examples of dyes that may be suitable for this purpose are visible, near-infrared and ultraviolet absorbing dyes from QCR Solutions Corp. (Port St. Lucie, Fla., USA), visible light and near-infrared absorbing dyes from Epolin (Newark, N.J., USA), ultraviolet absorbing dies from H.W. Sands Corp. (Jupiter, Fla., USA), and infrared absorbing materials (e.g., cyanine, squarylium and croconium dyes, known for use in laser welding polymer fabric materials). If the electromagnetic energy absorbing medium is not stable under the operating conditions of the hydrogen generator, it desirably will not produce undesirable reaction products, such as a fuel cell poison. A secondary hydrogen-producing reactant or an ignition material may be useful as an electromagnetic energy absorbing medium.

It may be desirable to include an ignition material in the fuel unit, especially if the reactant is endothermic. An ignition material reacts exothermically when heated and can be used in conjunction with the initiation system to provide heat to initiate the hydrogen-producing reaction of the reactant. An ignition material can provide a number of advantages. The temperature to which the ignition material must be heated to react may be lower than the minimum reaction temperature of the reactant, reducing the heat producing requirement for the initiation system. Because the ignition material reacts exothermically, it can reduce the total amount of energy that must be supplied to the initiator during use of the fuel unit, particularly if the thermal decomposition reaction of the reactant is endothermic. An ignition material can be an ingredient of the reaction composition, or it can be in a separate layer or other mass in contact with a layer of the reactant composition. Some types of ignition materials can also produce hydrogen gas when they react, contributing to the total amount of hydrogen the fuel unit can provide. Examples of ignition materials include iron powder or TiH₂ plus KClO₄, MnO₂ plus LiAlH₄, Ni plus Al, Zr plus PbCrO₄, Fe₂O₃ plus Al (thermite), and LiAlH₄ plus NH₄Cl. It will be understood that references herein to initiating a reaction in a hydrogen-generating reactant can include initiating a heat-generating reaction in an ignition material that in turn initiates a hydrogen-generating reaction.

The reaction composition and any additional layers can be applied to the substrate by any suitable method. Examples include spraying, printing, roll coating, extruding, adhesive laminating and pressure laminating.

In order to provide hydrogen gas on an as-needed basis without developing a high internal pressure within the hydrogen generator, it can be advantageous to be able to react limited quantities of reactant. In embodiments in which the hydrogen-generating reaction is not self-sustaining after initiation, hydrogen generation can be stopped by merely turning off the initiator and allowing the reaction composition to cool. By periodically realigning the fuel unit and the laser beam, improved reaction efficiency can be achieved. The distance the heat produced by the laser must travel is limited, thereby limiting the effects of reaction products that do not have a high thermal conductivity as well as limiting parasitic heat loses. Segregating limited quantities of reactant composition can also improve the reaction efficiency. To initiate reaction in individual segregated quantities of reactant composition, the fuel unit and laser beam can be aligned so the segregated quantities can be selectively irradiated. In embodiments in which the hydrogen-generation reaction is self-sustaining (consuming essentially all the reactant in a quantity of reaction composition once reaction is initiated), the amount of reactant that can be reacted as a result of a single initiation event can be limited by segregating quantities of reactant composition. Segregation can be accomplished by positioning gaps, ridges in the substrate disc, thermally insulating materials and combinations thereof between quantities of the reactant composition for example.

The alignment of the fuel unit and the laser beam is changed using the indexing mechanism. One or both of the disc and the laser beam can be moved to change the portion of the fuel unit onto which the laser beam is projected. The indexing mechanism includes one or both of a disc rotating device, for rotationally moving the disc from a first disc position to a second disc position, and a laser positioning device for moving the laser beam from a first laser position to a second laser position. The disc rotating device and the laser positioning device can be used in various combinations to irradiate portions of the reactant composition in a desired sequence. For example, it may be desirable to irradiate adjacent portions in sequence (e.g., to use heat from one portion to preheat the next portion), or to irradiate separated portions in sequence (e.g., to prevent overheating areas of the fuel unit). The same energy source(s) used for the initiation system can be used to power this mechanism. To minimize the amount of energy needed to operate the indexing mechanism, the indexing mechanism moves both the disc and the laser beam incrementally so only a selected portion of the reactant composition is irradiated. In embodiments where the laser beam does not strike a significant area of the targeted portion of reactant composition, including a good thermal conductor as the substrate or a coating thereon can facilitate sufficient heating of all of the reactant in that portion of the reactant composition.

The disc rotating device can include any mechanism suitable for indexing the disc from a first position to a second position. For example, the disc rotating device can include one or more of a stepper motor, a ratchet mechanism, a chain drive, a belt drive, a worm drive, and a friction wheel drive. In one embodiment, a disc rotating device similar to the disc drive system in a compact disc player can be used, with appropriate modifications such as providing an indexing rather than continuous rotation. The disc can rest on a base that is rotated, or the disc may be held in place at its periphery or at a central hole. One or more features can be included on an edge or surface of the fuel unit to cooperate with the disc rotating device to rotate the fuel unit. For example, teeth could be added to the outer edge or around a center hole of the substrate, serving as gear teeth, or a gear feature could be added to the outer surface of the substrate. Other features, such as projections from or indentations in the outer surface of the substrate, can be included to facilitate rotation and/or alignment of the fuel unit. A surface of the substrate can include an area (e.g., an edge or an annular band on the outer surface) against which a friction wheel can turn; this surface can be smooth or roughened. An example of a ratchet mechanism that can be adapted to rotate the disc is disclosed in commonly owned provisional U.S. Patent Application No. 61/560,444, entitled Hydrogen Generator for a Fuel Cell, filed on Nov. 16, 2011. The disclosed feed system includes a sprocket that is rotated by the action of a bellows on a ratchet wheel. The bellows has a flexible chamber that expands and contracts with the changing pressure differential between the inside and outside of the housing, so that the feed system is thus responsive to the need for additional hydrogen. This feed system can be adapted to the present hydrogen generator by incorporating a sprocket into the fuel unit, such on an outer surface of the substrate, or by forming sprocket teeth on the outside diameter of the substrate or the inside diameter of a center hole.

A moveable laser can be disposed in the holder in any suitable manner. For example, it can move along a track, such on a rail or in a groove, swing on a pivoting support arm, or be mounted on a base that can be rotated and/or tilted to aim the laser beam at a variety of targets. In an embodiment the laser positioning device can be similar to a tracking mechanism in a compact disc player. Compact disc players have used at least swing-arm and radial track mechanisms. Alternatively, the laser can remain stationary and one or more adjustable mirrors can be used to reflect the laser beam to redirect it. The laser positioning device can include any mechanism suitable for indexing the laser beam from a first position to a second position. For example, the laser positioning device can include one or more of a stepper motor, a ratchet mechanism, a chain drive, a belt drive, a worm drive, a friction wheel drive, and one or more mirrors.

The arrangement of segregated quantities of reactant composition can be selected to require only one of a disc rotating device or a laser positioning device in the hydrogen generator. For example, the reactant composition can be segregated into generally wedge-shaped areas radiating from the center of the disc so just rotating the disc is sufficient to selectively initiate the individual quantities as needed. In another example, the reactant composition can be segregated into concentric annular bands so just repositioning the laser is sufficient to selectively initiate the individual quantities. Other arrangements of the segregated quantities of reactant composition can be used, such as a honeycomb array or an array of other shapes. Some arrangements of the segregated quantities of reactant composition will require both an indexing mechanism with both a disc rotating device and a laser positioning device. The number, sizes, shapes and positioning of the segregated quantities of reactant composition can be chosen based on many factors, such as the maximum amount of hydrogen to be produced from a single quantity, maximizing the amount of reactant composition that can be contained on the disc, the heat generating capability of the laser, providing adequate thermal insulation between adjacent quantities, simplifying initiation control, ease of manufacturing, facilitating complete reaction, and so on. It may be desirable to change the area of reactant composition covered by the laser beam. This can be accomplished by using one or more lenses to broaden or narrow the beam.

A control system can be used to control the supply of energy from a source to the initiation system, such as by turning the initiator on and off or by adjusting the power level. It can also be used to control the indexing mechanism that changes alignment of the laser beam with the fuel unit. The control system can determine the need for hydrogen and/or the required hydrogen flow rate by monitoring parameters of the hydrogen generator, the remainder of the fuel cell system and the electronic device being supplied with power by the fuel cell battery. The parameters can include any one or combination of the pressure within the fuel cell system, one or more electrical characteristics of the fuel cell stack, or one or more electrical characteristics of the electronic device, for example. The controller may communicate with the device or the fuel cell stack to determine when more hydrogen is needed. The control system can monitor and manage temperatures of the hydrogen generator, the fuel cell system and the device. Portions of the control system can be disposed in the hydrogen generator, the fuel cell stack, the electronic device being powered by the fuel cell stack, or any combination thereof. The control system can include a microprocessor or microcontroller; digital, analog and/or hybrid circuitry; solid state and/or electromechanical switching devices; capacitors, sensing instrumentation, timers and so on. The same or a different control system can also be used for other purposes, such as identifying hydrogen generators and fuel units that are appropriate or approved for use, preventing use of inappropriate or unapproved hydrogen generators and fuel units, controlling charging of batteries in the fuel cell system and the device by the fuel cell battery, calculating and providing information on the remaining capacity of the fuel unit(s), recording historical information regarding the use of fuel units, the hydrogen generator, the fuel cell system and the device, preventing operation of the hydrogen generator under unsafe conditions, and other purposes.

The fuel unit can be any desirable size. For example, it may be convenient to have a fuel unit with a diameter between about 50 mm and about 150 mm If a center hole is needed, the hole could be between about 5 mm and about 15 mm in diameter. If modified components designed for use with a compact disc player are used in the hydrogen generator, the fuel unit can be sized accordingly. A common compact disc size has an outside diameter of about 120 mm and a central hole diameter of about 15 mm.

The fuel unit can include a package, to protect the fuel unit from exposure to the environment prior to use, to provide protection against damage during shipping and handling, and to limit or prevent direct contact with the user. The package can serve as a dispenser to dispense fuel units as needed, as describe below. The package can serve as a storage unit to store spent fuel units for disposal or recycling. This can avoid the user having to handle hot fuel units. The package design and materials will be selected based on the intended purposes. In one embodiment the package can be a metal laminated polymer film that can be heat- or adhesive-sealed.

A dispenser package containing multiple fuel units can be used to dispense individual fuel units. Dispensing can be done manually, either outside the hydrogen generator or from a dispenser within the hydrogen generator. Alternatively, the hydrogen generator and dispenser can be designed so that the dispenser can be loaded into the holder, with individual fuel units dispensed automatically as needed (e.g., similar to a compact disc changer). Dispensing new fuel units can be accompanied by ejection of spent fuel units. Ejection can include movement of a spent disc into a storage area within the hydrogen generator or removal from the hydrogen generator. Various types of dispenser designs can be used, including an external cartridge containing multiple fuel units that is loaded into the hydrogen generator and an internal cartridge that is a part of the hydrogen generator and into which individual fuel units can be loaded. The dispenser can contain fuel units in a stack or in a carousel for example. An external cartridge can also be used to store used fuel units, avoiding the need for a user to handle individual fuel units. Cartridges included in or used with compact disc players are examples of types of dispensers that can be used with the hydrogen generator.

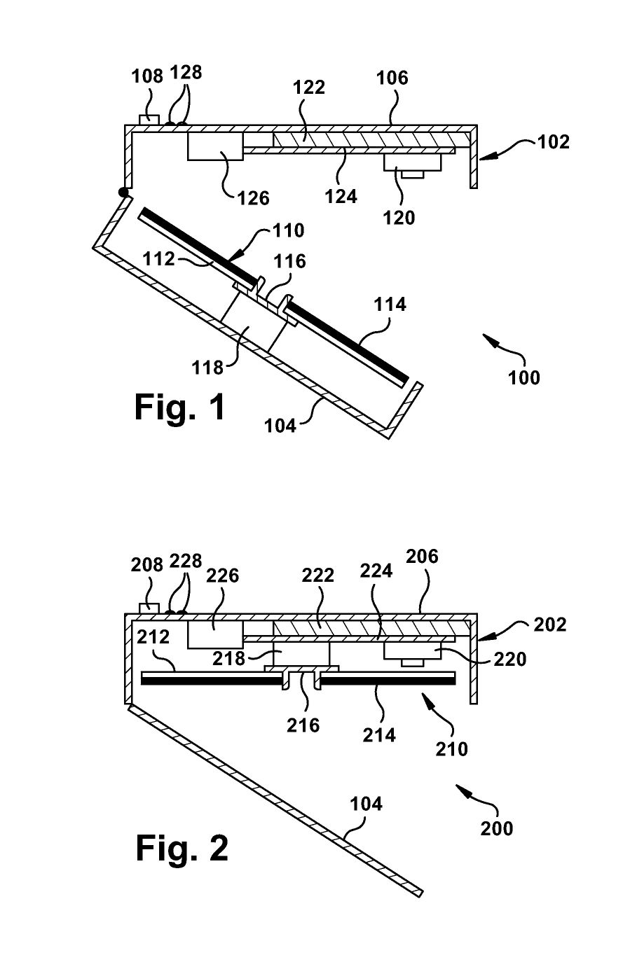

An embodiment of a hydrogen generator as described above is shown in FIG. 1. Hydrogen generator 100 has a holder 102 that can be installed in or otherwise connected to the remainder of a fuel cell system (not shown) that uses hydrogen gas produced by the hydrogen generator 100. The holder 102 includes two sections 104, 106 defining a cavity into which a fuel unit 110 can be contained. The holder sections 104, 106 can be opened (as shown in FIG. 1), to allow replacement of a used fuel unit 110 with an unused fuel unit 110, and closed to provide a sealed container capable of holding a limited quantity of hydrogen gas under pressure so that hydrogen gas that is produced is only able to exit the holder 102 through a hydrogen outlet 108 to the rest of the fuel cell system. Within the holder 102 are a disc rotating device that includes a disc drive 116, onto which the fuel unit 110 can be loaded, and a disc drive motor 118 for rotating the disc drive 116 and fuel unit 110. Also within the holder is a laser positioning device that includes a track 122, on which a laser 120 is mounted, and a worm gear 124 driven by a laser tracking motor 126. The track 122 is parallel to the fuel unit 110 when sealed within the hydrogen generator 100, and the laser 120 can be moved radially within the track 122 by the worm gear 124. When the hydrogen generator 100 is connected to the rest of the fuel cell system, the hydrogen outlet 108 is in fluid communication with a fuel cell battery, such as through a hydrogen gas plenum. The hydrogen outlet 108 can include a coupling mechanism for creating a gas-tight seal with the hydrogen flow path in the other part of the fuel cell system. It can also include valving to control the flow of hydrogen from the outlet 108. The fuel unit 110 includes a disc-shaped substrate 112 and a reactant composition 114 disposed on a surface of the substrate 112. During use of the hydrogen generator 100, the laser 120 projects a laser beam on a first portion of the reactant composition 114, irradiating the first portion of the reactant composition. The irradiation generates sufficient heat to cause a reactant in the reactant composition 114 to react by thermal composition, producing hydrogen gas. The hydrogen gas is provided to the fuel cell battery through hydrogen outlet 108. When the reactant in the first portion of the reactant composition 114 is essentially consumed, the indexing mechanism realigns the laser beam and the fuel unit 110 so a second portion of the reactant composition 114 can be irradiated by the laser beam. The laser beam and fuel unit 110 are realigned by rotating the fuel unit 110, repositioning the laser 120 or a combination thereof The fuel unit 110 is rotated and the laser 150 is repositioned by only discrete amounts, rather than being moved continuously during operation of the hydrogen generator 100, in order to minimize the amount of energy that is required. One or more energy sources can be used to provide power to the laser 120, the disc drive motor 118 and the laser tracking motor 126. The energy source(s) can be outside the holder 102. When the hydrogen generator 100 is connected to the fuel cell system, electrical connections to the energy source(s) can be made through electrical contacts 128 that extend through the holder 102.

The hydrogen generator 100 in FIG. 1 can be modified in any manner disclosed above. For example, the size and shape of the hydrogen generator 100 can be modified, the arrangement of the components can be changed, and different types of disc rotating devices and laser positioning devices can be used. FIG. 2 shows another embodiment of a hydrogen generator that is a modification of the embodiment in FIG. 1.

In FIG. 2, hydrogen generator 200 has components similar to those of hydrogen generator 100. Similar components are identified in the drawings with similar reference numbers, with the components of hydrogen generator 100 being 3-digit numbers beginning with “1”, and the corresponding components of hydrogen generator differing only by beginning with “2”. Hydrogen generator 200 differs from hydrogen generator 100 in several ways. First, in hydrogen generator 100 the laser beam is projected onto the surface of the fuel unit 110 on which the reactant composition 114 is disposed, but in hydrogen generator 200 the laser beam is projected through the substrate 212 of the fuel unit 210 to irradiate the internal surface of the reactant composition 214. This requires that the substrate 212 be highly transparent to electromagnetic radiation of the wavelength in the laser beam. Second, in hydrogen generator 100 the laser 120 and the laser positioning device are disposed on one side of the fuel unit 110, while the disc rotating device are disposed on the opposite side of the fuel unit 110; but in hydrogen generator 200 both the disc rotating device and the laser positioning device are disposed on the same side of the fuel unit 210. This can simplify the holder lid (holder section 204), and the entire indexing mechanism can be contained within the other holder section 206, where it is better protected from possible damage.

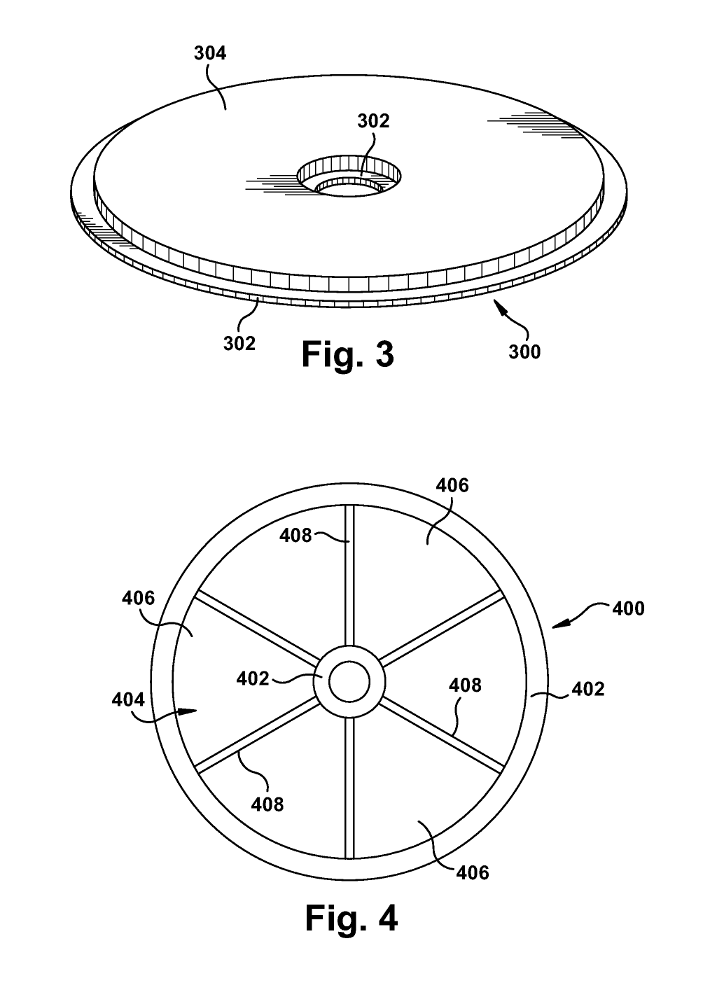

As disclosed above, the reactant composition can be disposed on the fuel unit substrate as a continuous or a discontinuous layer. An example of a fuel unit with a continuous reactant composition layer is shown in FIG. 3. The fuel unit 300 includes a substrate 302 and a reactant composition 304 in a layer that extends over most of the surface of the substrate 302. The reactant composition 304 is not segregated into smaller quantities. An advantage of fuel unit 300 is ease of manufacture.

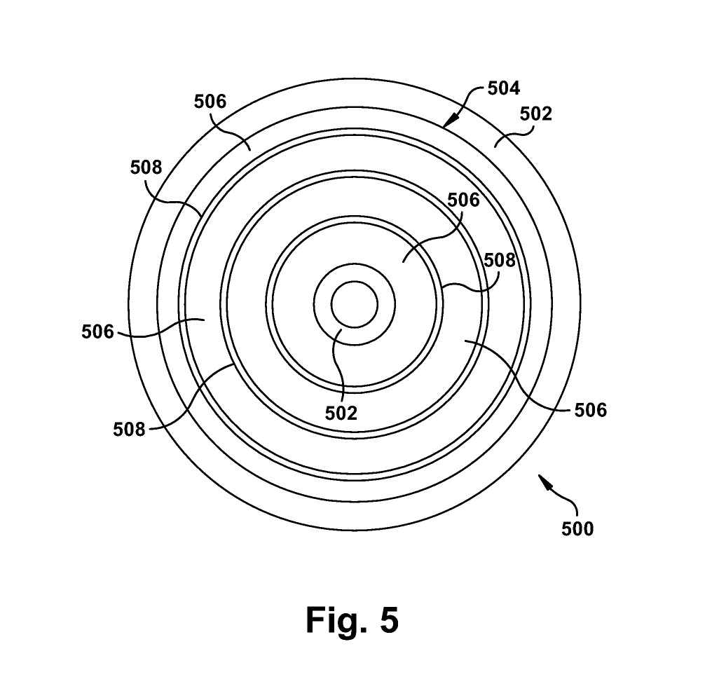

There can be advantages to segregating the reactant composition into smaller quantities. The smaller quantities can have many different sizes and shapes and can be arranged in many ways. Two examples are shown in FIGS. 4 and 5, which are views of the fuel units from the side on which the reactant composition is disposed. As shown in FIG. 4, fuel unit 400 has a substrate 402 with a reactant composition 404 in a layer on a surface of the substrate 402. The reactant composition 404 is segregated into a plurality of wedge-shaped quantities 406 by separators 408. The separators 408 can be gaps between adjacent quantities 406, or they can be structures, such as ridges projecting from the substrate 402, pieces of thermal insulation applied to the surface of the substrate 402 and the like. FIG. 4 shows six wedge-shaped quantities 406, but more or fewer can be used. In fuel unit 400, the wedge-shaped quantities 406 extend from the most central part of the layer of reactant composition 404 to the outermost part of the layer of reactant composition 404. In such an embodiment the indexing mechanism of the hydrogen generator can have only a disc rotating device; a laser positioning device is not required.

Fuel unit 500 in FIG. 5 includes a substrate 502 with a layer of reactant composition 504 on its surface. The reactant composition 504 is segregated into a plurality of quantities 506 in the form of annular bands. As in fuel unit 400, the quantities 506 are segregated by separators 508, which can be similar to separators 408. Four quantities 506 are shown in FIG. 5, but more or fewer can be used. In fuel unit 500, the indexing mechanism of the hydrogen generator can have only a laser positioning device; a disc rotating device is not required.

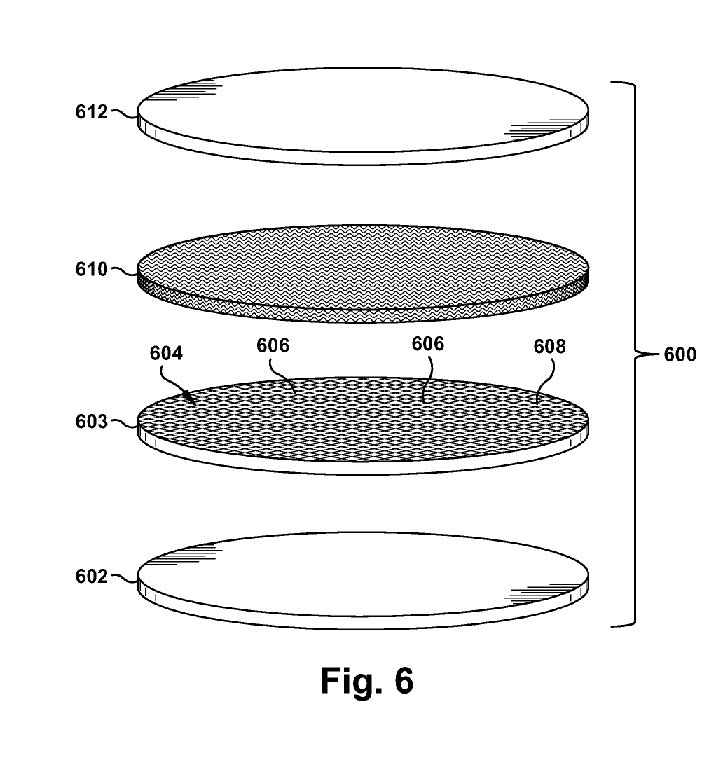

Fuel units can be further modified by adding additional layers. For example, in FIG. 6 fuel unit 600 includes a substrate 602 and a reactant layer 603 that includes quantities 606 of reactant composition 604 segregated by separators 608. The segregated quantities 606 and separators 608 can be arranged in any desired configuration, with various shapes and sizes, as described above. Fuel unit 600 further includes a cover layer 612, which can retain the reactant composition 604 as well as reaction byproducts. A porous layer 610 is disposed between the reactant layer 603 and the cover layer 612. The porous layer 610 provides a flow path for hydrogen gas to escape, and it can also serve as a filter to contain particulate material within the fuel unit 600. Porous layer 610 may not be required if hydrogen gas can otherwise escape from the fuel unit 600 (e.g., if the cover layer 612 is sufficiently porous or includes structures such as ridges or grooves in the surface facing the reactant layer 603. Other layers can be added. For example, if it desirable to be able to preheat the reactant composition 604 before initiating the reaction with a laser, a layer including one or more heating elements can be disposed between the cover layer 612 and the reactant layer 603, or the cover layer can be modified to include one or more heating elements. In fuel unit 600, the layers on at least one side of the reactant layer 603 must be made of materials that will allow the laser beam to pass therethrough with minimal loss in power. For example, the substrate 602 or the cover layer 612 and any intermediate layers can be made from clear materials. such as a clear polycarbonate, through which electromagnetic radiation from the laser can pass with high efficiency. Fuel unit 600 is shown without a central hole. A central hole may not be needed, depending on the type of disc rotating device used. A central hole can be included if needed. In some embodiments the substrate 602 and reactant layer 603 can be formed from a single piece of material by forming depressions in one surface of the material, leaving separators 608 between the depressions. Reactant composition 604 can be deposited in the depressions to create the segregated quantities 606 of reactant composition 604.

In an example of a hydrogen generator, each fuel unit has a reactant composition containing aluminum hydride (alane) as a hydrogen generating reactant. Alane is advantageous because it is relatively dense and its thermal decomposition temperature is relatively low. Up to about 2 to 3 weight percent of polypropylene can be included as a binder. A substrate is formed from a 4 mm thick clear polycarbonate material in the form of a disc 10 cm in diameter and having a 1.5 cm central hole. Six wedge-shaped depressions are formed in one surface, in a pattern similar to that shown in FIG. 4. The depressions are 2 mm thick and are bounded by peripheral and central annular walls, as well as radial walls between the wedges. The wedge-shaped depressions are filled with reactant composition to form segregated quantities of reactant composition. Because alane has a light color, a small amount of an electromagnetic energy absorbing medium can be included in the reactant composition, or a thin layer of the electromagnetic energy absorbing medium can be deposited in the bottoms of the depressions before filling with reactant composition. A thin layer of fiberglass wool is applied over the reactant composition, and a 2 mm thick polycarbonate disc is secured over the fiberglass wool as a cover for the fuel unit. Short projections extending from the periphery of the cover toward the peripheral wall of the substrate provide a means of attaching the cover and also provide a gap between the substrate and the cover for hydrogen gas to escape from the fuel unit. The fuel unit contains a total of about 20 g of alane, which would provide the equivalent of about 16.7 Wh of consumer usable hydrogen gas for a 10 W device, assuming an overall fuel cell system efficiency of 25 percent of theoretical, considering the efficiency of the laser initiator, the parasitic heat loss in the hydrogen generator, and the efficiency of the fuel cell battery).

In an example of a hydrogen generator using the exemplary fuel unit described above, the hydrogen generator is part of a fuel cell system that contains a fuel cell stack that can provide electric energy to power an electronic device. The hydrogen generator holder preferably includes a 2 volt, 0.5 watt pulsed laser diode, with an emission wavelength in the range of visible light, and having approximate dimensions of 7 mm×7 mm×2.5 mm thick, with a cathode projecting from one 2.5 mm side. The laser and a disc rotating device are mounted on one wall of a cavity into which the fuel unit can be loaded. The disc rotating device includes a disc drive onto which the fuel unit can be loaded and held in place so it will not rotate freely. The disc drive and fuel unit are keyed so that when the fuel unit is loaded onto the disc drive, one of the wedges of reactant composition will be aligned with the laser beam. The disc drive is operated by a stepper motor that will rotate the disc drive and the fuel unit in increments of 60 degrees so one of the wedges will be aligned with the laser beam each time the disc rotating device is indexed. No laser positioning device is needed. The fuel unit is mounted on the disc drive with the substrate facing the laser. This arrangement is similar to that shown in FIG. 2, except that the laser positioning device (track 222, worm gear 224 and motor 226) is omitted, and the laser is mounted in a fixed position. After the fuel unit is loaded on the disc drive, the holder lid is closed to seal the cavity to contain hydrogen gas that is produced. The lid also has an interlock to prevent opening when the laser is operating or when the temperature of the fuel unit is above a set maximum.

Energy for operating the laser and the disc rotating device of the exemplary hydrogen generator is supplied from outside the holder via electrical contacts and circuitry. The energy source is a rechargeable battery (e.g., nickel-cadmium or nickel-metal hydride batteries and, if necessary, a direct current to direct current converter) located in the fuel cell system. The battery can be recharged by the fuel cell battery during operation of the fuel cell system. If necessary the battery can be recharged from an external source if the battery is not sufficiently charged for startup of the hydrogen generator. Because the thermal decomposition of alane is not a self-sustaining reaction, continued heating is required to continue the reaction.

Operation of the exemplary hydrogen generator is controlled by a control system. When there is a load on the fuel cell system, a control system sensor monitors the hydrogen pressure in the fuel cell system; if the pressure is below a minimum level, power is supplied to the laser, and if the pressure is above a maximum level, no power is supplied to the laser. If the hydrogen generator is not providing sufficient hydrogen gas to maintain the hydrogen pressure within the desired range, the control system provides power to the stepper motor to index the disc drive and align the next wedge of reactant composition with the laser beam. The control system includes a fuel unit temperature sensor and controls the lid interlock.

Hydrogen gas exits the exemplary hydrogen generator through a valve in a wall of the holder. The fuel cell system also includes a purge pump for purging air from the system before hydrogen gas is supplied to the fuel cell battery. The intended maximum hydrogen pressure within the hydrogen generator is about 1.3 atmospheres. A pressure relief vent is included in the hydrogen generator to release excessive pressure and prevent an uncontrolled release. Additional filter material and baffles can be included in the holder cavity, between the fuel unit and the hydrogen outlet valve.

It will be understood by those who practice the invention and those skilled in the art that various modifications and improvements may be made to the invention without departing from the spirit of the disclosed concept. The scope of protection afforded is to be determined by the claims and by the breadth of interpretation allowed by law.

What is claimed is:

1. A hydrogen generator comprising:
a holder; and,
a fuel unit;
wherein:
the fuel unit comprises a disc shaped substrate having two opposite planar surfaces, at least one of the surfaces having thereon a reactant composition that is a solid hydrogen containing a reactant capable of releasing hydrogen gas by a thermal decomposition reaction when heated to at least a minimum temperature;
the holder comprises a cavity in which the fuel unit can be removably contained;
a laser for projecting a beam of electromagnetic radiation onto a portion of the reactant composition to heat the reactant to at least the minimum temperature;
the holder further comprises an indexing mechanism for aligning the laser beam and an unreacted portion of the reactant composition, the indexing mechanism comprising one or both of a disc rotating device for rotationally indexing the disc from a first stationary disc position to a second stationary disc position and a laser positioning device for indexing the laser beam from a first laser position to a second laser position over the disc when stationary.

2. The hydrogen generator according to claim 1, wherein the reactant includes aluminum hydride or an aluminum hydride compound.

3. The hydrogen generator according to claim 1, wherein the reactant composition contains one or more additives, admixed with, adjacent to, underlying or covering a portion of the reactant composition.

4. The hydrogen generator according to claim 3, wherein the additives can include one or a combination of an electromagnetic energy absorbing medium, a binder, a stabilizing compound, a thermally conductive material and an ignition material.

5. The hydrogen generator according to claim 1, wherein the reactant composition is free of catalysts.

6. The hydrogen generator according to claim 1, wherein the reactant composition is segregated into individual portions.

7. The hydrogen generator according to claim 1, wherein the laser can be turned on and off to provide hydrogen gas as needed.

8. The hydrogen generator according to claim 1, wherein the laser is a laser diode.

9. The hydrogen generator according to claim 1, wherein the laser uses pulsed power.

10. The hydrogen generator according to claim 1, wherein the disc rotating device includes one or more of a stepper motor, a ratchet mechanism, a chain drive, a belt drive and a worm drive for indexing the disc from the first stationary disc position to the second stationary disc position.

11. The hydrogen generator according to claim 1, wherein the laser positioning device includes a stepper motor, a ratchet mechanism, a chain drive, a belt drive, a worm drive and one or more mirrors for indexing the laser beam from a first laser position to a second laser position over the stationary disc.

12. The hydrogen generator according to claim 1, wherein the holder includes a housing, and the housing can include portions of at least one of a fuel cell system and a device with which the fuel cell system or the hydrogen generator is used.

13. The hydrogen generator according to claim 1, wherein the hydrogen generator includes an energy source for providing energy to the laser and the indexing mechanism.

14. The hydrogen generator according to claim 1, wherein the hydrogen generator includes a control system comprising one or a combination of a microprocessor; a microcontroller; digital, analog and hybrid circuitry; solid state and electromechanical switching devices; capacitors; and sensing instrumentation for controlling one or more of operation of the laser, operation of the indexing mechanism, and monitoring one or more parameters indicative of a need for hydrogen.

15. The hydrogen generator according to claim 1, wherein the fuel unit is portable.

16. The hydrogen generator according to claim 1, wherein the hydrogen generator is portable.

17. A fuel cell system including a fuel cell battery and a hydrogen generator according to claim 1.
